(19) United States
(12) Patent Application Publication
(10) Pub. No.: US 2010/0094979 A1
(43) Pub. Date: Apr. 15, 2010

(54) Network System, Server Apparatus, and Printer Driver

(75) Inventor: Osamu AZAMI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/561,090

(22) Filed: Sep. 16, 2009

(30) Foreign Application Priority Data
Oct. 15, 2008 (JP) 2008-266032

(51) Int. Cl. G06F 15/177

(52) U.S. Cl. 709/221

(57) ABSTRACT

A network system includes a first server on a service providing side, a second server on a service receiving side, and printer hosts and printers connected to a local network on the second server side. The second server stores information on printer driver versions installed to its printer hosts and firmware installed to its printers, and determines whether these are the latest versions by transmitting version information and the second server's company information to the first server. The first server stores the latest printer driver and firmware versions and information on companies to which they may be provided, and provides the second server with the latest versions when permitted and when they are newer than the version information transmitted from the second server.

### BACKGROUND

1. Technical Field

The present invention relates to technology for managing a printer that is connected to a network.

2. Related Art

Generally, users who purchased printers or users who installed printer drivers perform user registration individually for each maker and manage versions of the printer drivers, the firmware of the printers, and the like.

In addition, in companies or the like, there are cases where individual users are responsible for management of versions of printer drivers, firmware, or the like for information apparatuses such as printers that are owned by the companies. In such a case, an individual user searches for the latest version of a printer driver or the latest version of a firmware from a server of the maker and installs the latest version of the printer driver of or the latest version of the firmware.

For example, in JP-A-2006-235739, technology has been disclosed for downloading (automatic updating) the latest version of a printer firmware from a web server of a maker.

However, when user registration is performed by accessing an external network from each information apparatus inside the company, personal information or company secrets may be leaked. Accordingly, in such a case, there is a security problem.

### SUMMARY

An advantage of some aspects of the invention is that it provides a network system, a server apparatus, and a printer driver capable of managing printers that are connected to a network.

According to an aspect of the invention, there is provided a network system that includes: a first server that is located on a service providing side; a second server that is located on a service receiving side; a plurality of printer hosts that is connected to a local network on the second server side; and a plurality of printers that is connected to the local network. The second server includes: a memory unit that stores information on the versions of printer drivers installed to the plurality of printer hosts and firmware installed to the plurality of printers; and a version management unit that inquires whether there is the latest version of a printer driver or the latest version of a firmware by transmitting company information, which specifies a company that owns the second server, to the first server together with the version information on a regular basis. The first server includes: a first memory unit that stores the latest version of the printer driver and the latest version of the firmware; a second memory unit that stores permission information that is used for determining a company to which the latest version of the printer driver and the latest version of the firmware are permitted to be provided; and a providing unit that provides the second server with the latest version of the printer driver or the latest version of the firmware stored in the memory unit for cases where the latest version stored in the memory unit is newer than the version represented by the version information that has been transmitted from the second server only when the company information transmitted from the second server is included in the permission information. The version management unit of the second server notifies the printer host of the provision of the latest version of the printer driver for cases where the latest version of the printer driver is provided, and transmits the latest version of the firmware to the printer for cases where the latest version of the firmware is provided. The printer host includes: an acceptance unit that accepts a user's instruction indicating whether to download the latest version of the printer driver for cases where the notice is accepted; and a request unit that requests the second server for the latest version of the printer driver for cases where the instruction for downloading is accepted by the acceptance unit. The printer includes a firmware management unit that installs the latest version of the firmware transmitted from the second server.

### BRIEF DESCRIPTION OF THE DRAWINGS

The invention will be described with reference to the accompanying drawings, wherein like numbers reference like elements.

FIG. 1 is a diagram showing the hardware configuration of a network system according to an embodiment of the invention.

FIG. 2 is a diagram showing an example of the functional configuration of a first server.

FIG. 3 is a diagram schematically showing an example of a data structure of a company management table.

FIG. 4 is a diagram schematically showing an example of the data structure of a program management table in the first server.

FIG. 5 is a diagram showing an example of the functional configurations of a second server, an information processing terminal, and a printer.

FIG. 6 is a schematic diagram showing an example of the data structure of a terminal information table.

FIG. 7 is a schematic diagram showing an example of the data structure of a printer information table.

FIG. 8 is a schematic diagram showing an example of the data structure of a program management table in a second, server.

FIG. 9 is a schematic diagram showing an example of the data structure of a user management table.

FIG. 10 is a timing chart showing a registration process.

FIG. 11 is a timing chart showing a version update process.

FIG. 12 is a timing chart showing a fault detecting process.

FIG. 13 (upper stage) shows a flowchart of a process for cases where the IP address of a printer is changed, and FIG. 13 (lower stage) shows a flowchart of a process for cases where a printer driver installed to an information processing terminal is deleted.

### DESCRIPTION OF EXEMPLARY EMBODIMENTS

Hereinafter, an embodiment of the invention will be described with reference to the accompanying drawings.

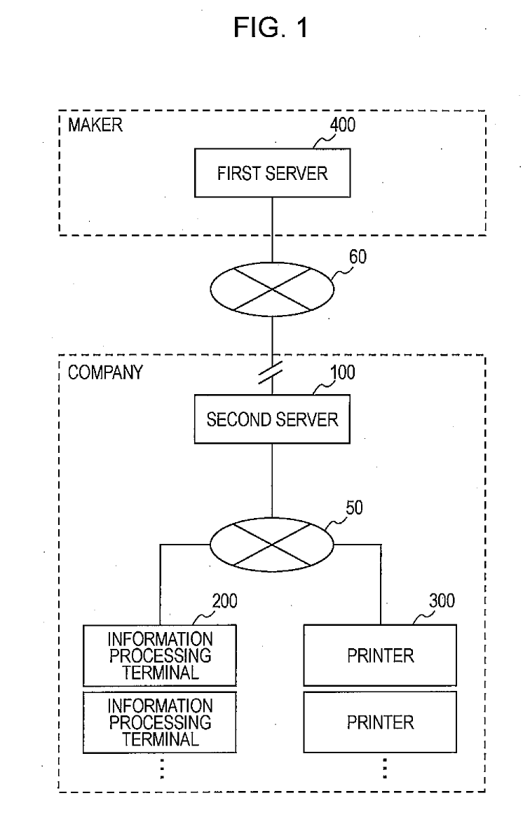

FIG. 1 is a block diagram showing the hardware configuration of a network system 10 according to an embodiment of the invention. As shown in the figure, the network system 10 includes a first server 400, a second server 100, a plurality of information processing terminals 200, and a plurality of printers 300.

The first server 400 is a server that is disposed inside the maker (manufacturing company) of the printer 300. The first server 400 performs the service of providing a latest printer driver or a latest firmware to users (include companies, organizations; and individuals) who have purchased the printer 300.

The second server 100 is a server that is disposed within a local network 50 (for example, a LAN or the like) built by a user (includes a company, an organization, and an individual) who owns the printer 300. The second server 100 receives services that are provided by the first server through a global network 60 (for example, the Internet or the like). In addition, the second server 100 manages information devices such as the information processing terminals 200, the printers 300, and the like that are connected to the local network 50.

The information processing terminal 200 is connected to the local network 50 and serves as a printer host of the printer 300.

The printer 300 is connected to the local network 50. The printer 300 is controlled by the information processing terminal 200 and performs printing operations.

For example, the first server 400, the second server 100, and the information processing terminal 200 are each realized by a general computer, not shown in the figure, that includes a CPU (central processing unit), a RAM (random access memory), a ROM (read only memory), a hard disk, and a network interface. However, the configuration of the computer is not limited thereto. Thus, the computer may be configured to include a USB interface, an output device for a portable storage medium, or the like.

In addition, for example, the printer 300 includes a CPU, a RAM, a ROM, a network interface, and a print engine that are not shown in the figure. However, the configuration of the printer 300 is not limited thereto. Thus, for example, the printer 300 may be configured to include a USB interface or the like. In addition, the printer 300 is not limited to a printer and, for example, may be a scanner device, a facsimile device, a multi-function device, or the like.

In addition, between the second server 100 and the first server 400, a server having a firewall function or the like may be disposed for the provision of security. Alternatively, the second server 100 may have the firewall function.

Next, a functional configuration that is implemented in the first server 400 of the above-described network system 10 will be described.

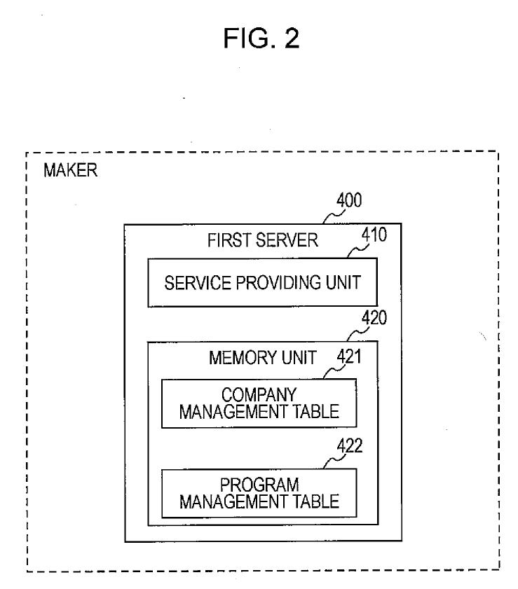

FIG. 2 is a block diagram showing an example of the functional configuration of the first server 400. As shown in the figure, the first server 400 includes a service providing unit 410 and a memory unit 420. The service providing unit 410 is configured by executing a computer program, which is loaded into the RAM of the first server 400, by using the CPU. In addition, the memory unit 420 is configured by a memory device such as a ROM or a hard disk.

The memory unit 420, as shown in, the figure, stores a company management table 421 and a program management table 422 therein.

The company management table 421 stores data for specifying a company to which the service provided by the first server 400 is permitted (hereinafter, referred to as a “service-permitted company”). In addition, although the company may be an organization or an individual, hereinafter, the organization or the individual will be collectively described as a “company”.

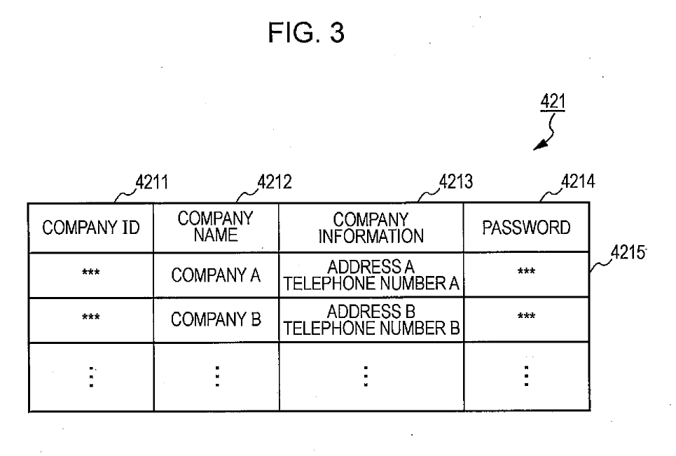

FIG. 3 is a diagram schematically showing an example of the data structure of the company management table 421. As shown in the figure, the company management table 421 is configured by records 4215 for each service-permitted company. Each record 4215 is added when a predetermined registration process is performed by a company owning the printer 300. In each record 4215, company identification information (company ID) 4211, a company name 4212, company information 4213, and a password 4214 are stored in association with one another.

The company ID 4211 is constituted by a character string (including a number string) that is used for identifying a service-permitted company. In addition, the company ID 4211 is used in a checking operation when access is requested from the second server 100 that is disposed in the service-permitted company.

The company name 4212 is data that specifies the name of the service-permitted company. For example, the company name 4212 is formed of a predetermined character string (including a number string).

The company information 4213 is data for specifying an address, a telephone number, or the like of the service-permitted company. For example, the company information 4213 is formed of a predetermined character string (including a number string).

The password 4214 is constituted by a character string (including a number string) that is designated by the company. Similarly to the above-described company ID 4211, the password 4214 is used in a checking operation when access is requested from the second server 100 that is disposed in the service-permitted company.

The program management table 422 stores data, which is used for managing the latest version of a printer driver (for installation) and the latest version of a firmware (for installation) therein.

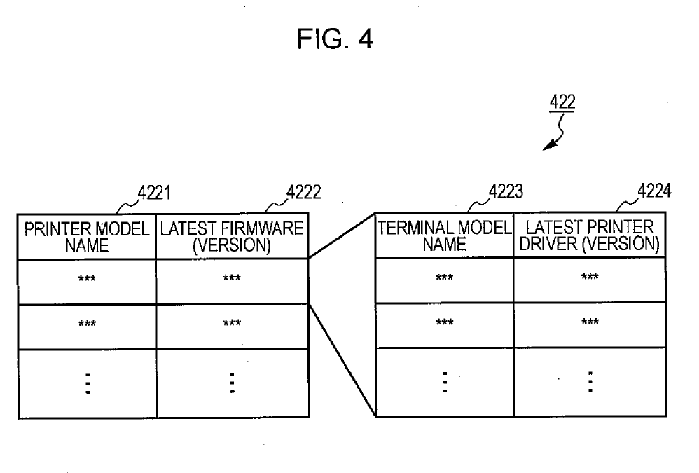

FIG. 4 is a diagram schematically showing an example of the data structure of the program management table 422. As shown in the figure, the program management table 422 is configured by records for the model name of each printer and for each terminal model name that are manufactured by the maker. Each record is updated each time when the latest version of the firmware (for installation) or the printer driver (for installation) is created. In each record, a printer model name 4221, a latest firmware 4222, a terminal model name 4223 for an information processing terminal (a plurality of information processing, terminals in the case where there is a plurality of information processing terminals) that can control the printer of the printer model name 4221, and a latest printer driver 4224 are stored in association with one another.

The printer model name 4221 is data that specifies the model name of a printer that is manufactured by the maker. For example, the printer model name 4221 is formed of a predetermined character string (including a number string).

The latest firmware 4222 is formed of the latest version of a firmware (for installation) that can be installed to a printer of the model specified by the printer model name 4221. However, the latest firmware 4222 may not be the firmware (program) itself but may be configured by data representing information on the version of the firmware or a storage place (for example, an address on the memory) for the firmware.

The terminal model name 4223 is data for specifying the model name of an information processing terminal (PC) that can control a printer of the printer model name 4221. For example, the terminal model name 4223 is formed of a predetermined character string (including a number string).

The latest printer driver 4224 is configured by the latest version of a printer driver (for installation) that can be installed to an information processing terminal (PC) of the model name that is specified by the terminal model name 4223. However, the latest printer driver 4224 may not be the latest version of the printer driver as long as it corresponds to the latest firmware 4222. Furthermore, the latest firmware 4222 may not be the printer driver (program) but may be configured by data representing information on the version of the printer driver or a storage place (for example, an address on the memory) for the printer driver.

With reference back to FIG. 2, the service providing unit 410 performs a process of registering a user (company) when the user (company) who purchased the printer 300 requests the starting of the provision of the service. In particular, the service providing unit 410 adds the above-described data (the company ID 4211, the company name 4212, the company information 4213, and the password 4214) in the company management table 421. Accordingly, the company that owns the second server 100 is registered as a service-permitted company in the first server 400.

In addition, the service providing unit 410 provides the user (company) who purchased the printer 300 with the latest version of the printer driver (for installation) and the firmware (for installation) of the latest version. In particular, in response to a regular inquiry from the second server 100, the service providing unit 410 searches for latest version of the printer driver the that is newer than the printer driver installed to the information processing terminal 200 or the latest version of the firmware that is newer than the firmware installed to the printer 300 from the program management table 422 and provides the found printer driver or the firmware.

Next, the functional configurations implemented in the second server 100, the information processing terminal 200, and the printer 300 of the network system 10 will be described.

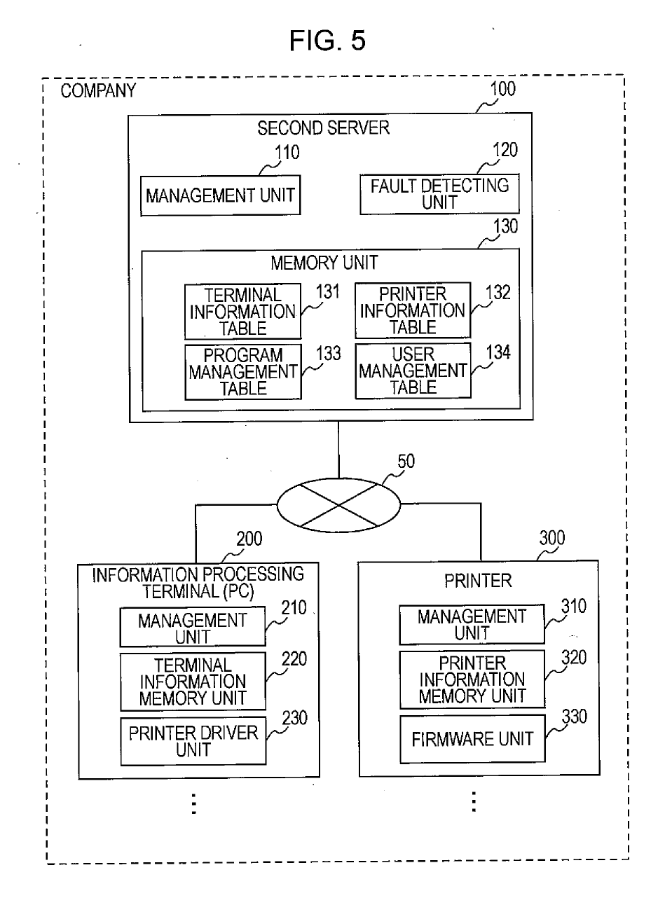

FIG. 5 is a block diagram showing an example of the functional configurations of the second server 100, the information processing terminal 200, and the printer 300. As shown in the figure, the second server 100 includes a management unit 110, a fault detecting unit 120, and a memory unit 130. The management unit 110 and the fault detecting unit 120 are configured by executing a computer program that is loaded in the RAM of the second server 100 by using a CPU. In addition, the memory unit 130 is configured by a memory device such as a ROM or a hard disk.

The memory unit 130, as shown in the figure, stores a terminal information table 131, a printer information table 132, a program management table 133, and a user management table 134 therein.

The terminal information table 131 stores information on the information processing terminals (PC) 200 that are managed by the second server 100 (company).

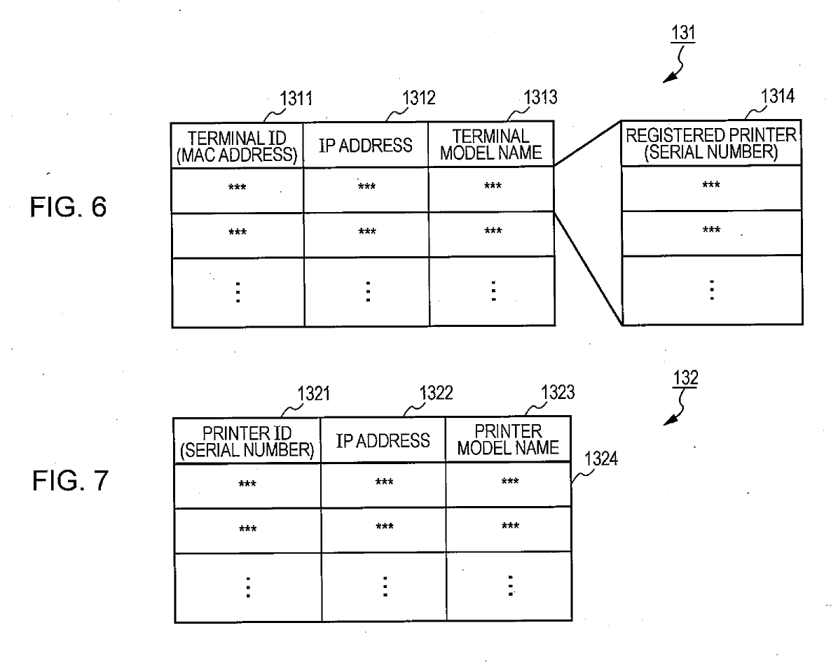

FIG. 6 is a schematic diagram showing an example of the data structure of the terminal information table 131. As shown in the figure, the terminal information table 131 is constituted by records 1216 for each information processing terminal (PC) 200 that is managed by the second server 100 (company). Each record 1216 is added when an information processing terminal 200 is introduced in the company (the local network 50). In each record, the terminal identification information (terminal ID) 1311, the IP address 1312, the terminal model name 1313, the printer driver version information 1314 (a plurality of the printer driver versions for cases where there is a plurality of the printer driver versions), and a registered printer 1315 (a plurality of the registered printers for cases where there is a plurality of the registered printers) are stored in association with one another.

The terminal ID 1311 is a character string (including a number string) that is used for identifying the information processing terminal (PC) 200. For example, the terminal ID 1311 is configured by a unique MAC address that is assigned to the information processing terminal (PC) 200.

The IP address 1312 is an IP address that is assigned to the information processing terminal (PC) 200 on the local network 50. When there is a change in the actual IP address of the information processing terminal (PC) 200, the IP address 1312 in the terminal information table 131 is updated as needed.

The terminal model name 1313 is data for specifying the model name of the information processing terminal 200 that is connected to the local network 50. For example, the terminal model name 1313 is formed of a predetermined character string (including a number string).

The printer driver version information 1314 is data that specifies the version of a printer driver that is actually installed to the information processing terminal 200. For example, the printer driver version information 1314 is formed of a predetermined number string (including a character string). In addition, when a plurality of printer drivers is installed to the information processing terminal 200, the printer driver version information 1314 has data for specifying the version of each printer driver. When there is a change in the version of the printer driver that is installed to the information processing terminal 200, the printer driver version information 1314 in the terminal information table 131 is updated as needed.

The registered printer 1315 is a character string (including a number string) for identifying a printer that is registered as a printer controlled by the information processing terminal 200 of the terminal ID 1311. For example, the registered printer 1315 is formed of a unique serial number that is assigned to the printer.

Next, the printer information table 132 stores information on the printer 300 that is managed by the second server 100 (company) therein.

FIG. 7 is a schematic diagram showing an example of the data structure of the printer information table 132. As shown in the figure, the printer information table 132 is constituted by records 1325 for each printer 300 that is managed by the second server 100 (company). Each record 1325 is added when a printer 300 is introduced in the company (the local network 50). In each record 1325, printer identification information (printer ID) 1321, an IP address 1322, a printer model name 1323; and firmware version information 1324 are stored in association with one another.

The printer ID 1321 is data associated with the registered printer 1314. For example, the printer ID 1321 is formed of a unique serial number that is assigned to the printer 300.

The IP address 1322 is an IP address that is assigned to the printer 300 on the local network 50.

The printer model name 1323 is data for specifying the model name of a printer 300 that is connected to the local network 50. For example, the printer model name 1323 is formed of a predetermined character string (including a number string).

The firmware version information 1324 is data that specifies the version of a firmware that is actually installed to the printer 300. For example, the firmware version information 1324 is formed of a predetermined number string (including a character string). When there is a change in the version of the firmware that is installed to the printer 300, the firmware version information 1324 in the printer information table 132 is updated as needed.

Next, the program management table 133 stores a firmware actually installed to the printer 300 that is managed by the second server 100 (company) therein. In addition, in the program management table 133, a printer driver actually installed to the information processing terminal 200 that is managed by the second server 100 (the company) is stored.

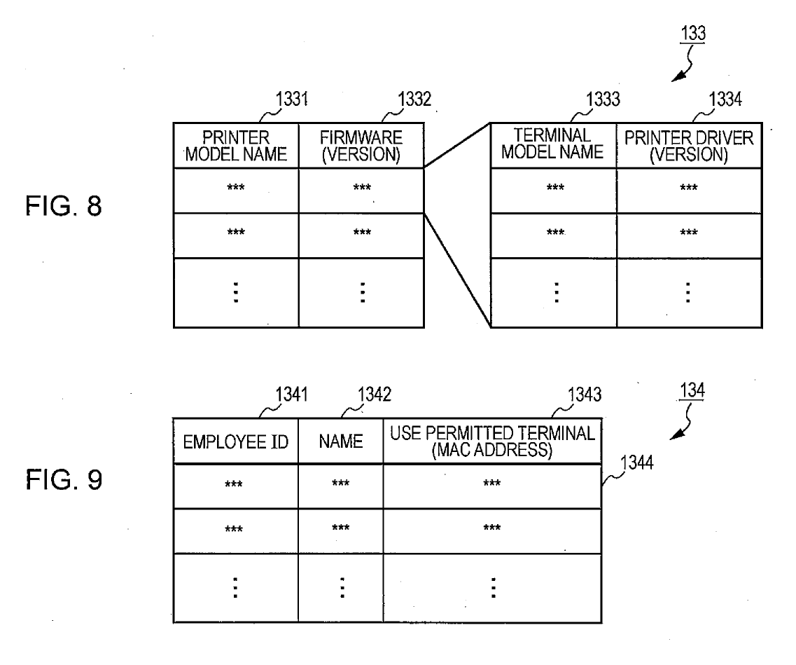

FIG. 8 is a schematic diagram showing an example of the data structure of the program management table 133. As shown in the figure, the program management table 133 is configured by records for the printer model name of each printer 300 and for each terminal model name that are managed by the second server 100 (the company). Each record is added when a printer 300 of a model or an information processing terminal 200 of a model that has never been managed by the second server 100 is introduced in the company (the local network 50). In each record, a printer model name 1331, a firmware 1332, a terminal model name 1333 for an information processing terminal (a plurality of information processing terminals for cases where there is a plurality of information processing terminals) that can control the printer of the printer model name 1331, and a printer driver 1334 are stored in association with one another.

The printer model name 1331 is data associated with the printer model name 1323 in the printer information table 132. For example, the printer model name 1331 is formed of a predetermined character string (including a number string).

The firmware 1332 is formed of the latest version of a firmware to be installed to a printer of the model that is specified by the printer model name 1331. However, the firmware 1332 may not be a firmware (program) itself but may be formed of data that represents firmware version information or the storage place (for example, an address on the memory) for the firmware. In addition, the firmware 1332 is updated each time when the latest firmware 4222 is acquired from the first server 400.

The terminal model name 1333 is data associated with the terminal model name 1313 in the terminal information table 131. For example, the terminal model name 1333 is formed of a predetermined character string (including a number string).

The printer driver 1334 is formed of the latest version of a printer driver to be installed to an information processing terminal of the model that is specified by the terminal model name 1333. However, the printer driver 1334 may not be a printer driver (program) itself but may be configured by data representing information on the version of the printer driver or a storage place (for example, an address on the memory) for the printer driver. In addition, the printer driver 1334 is updated each time when the latest printer driver 4224 is acquired from the first server 400.

In addition, the printer driver 1334 may not be the latest version but may be a correct version that is recommended (designated) by the company. In such a case, the printer driver 1334 is appropriately updated by a supervising user.

Next, the user management table 134 stores data used for managing users (employees) belonging to the company that owns the second server 100.

FIG. 9 is a schematic diagram showing an example of the data structure of the user management table 134. As shown in the figure, the user management table 134 is constituted by records 1344 for each user (employee). Each record 1344 is added when a predetermined registration process for a user (employee) is performed. In each record 1344, employee identification information (an employee ID) 1341, a name 1342, and a use-permitted terminal 1343 are stored in association with one another.

The employee ID 1341 is formed of a character string (including a number string) for identifying a user (employee). In addition, the employee ID 1341 is used for checking at the time when access is requested from the information processing terminal 200.

The name 1342 is data for specifying the name of a user (employee). For example, the name 1342 is formed of a predetermined character string.

The user-permitted terminal 1343 is data for specifying an information processing terminal 200 that is permitted to be used by a user (employee). For example, the user-permitted terminal 1343 is data associated with the terminal ID 1311.

Referring back to FIG. 5, the management unit 110 manages the information processing terminal 200 and the printer 300 that are connected to the local network 50. For example, the management unit 110 registers the information processing terminal 200 and the printer 300 that are connected to the local network 50 (hereinafter, referred to as a “registration process”). In addition, the management unit 110 makes inquiries to the first server 400 on a regular basis to determine whether there is the latest version of a printer driver and the latest version of a firmware. When there is the latest version of the printer driver or the latest version of the firmware, the management unit 110 acquires it (hereinafter, referred to as a “version update process”).

The fault detecting unit 120 detects a printer driver that has been incorrectly installed to the information processing terminal 200 (hereinafter, referred to as a “fault detecting process”). In particular, the fault detecting unit 120 acquires information on the version of the printer driver that has been installed to the information processing terminal 200. When the acquired version information does not coincide with information on the version of the printer driver 1334 that is registered in the program management table 133, the fault detecting unit 120 determines that the printer driver has been incorrectly installed.

Next, the information processing terminal 200, as shown in the figure, includes a management unit 210, a terminal information memory unit 220, and a printer driver, unit 230. The management unit 210 and the printer driver unit 230 are configured by executing a computer program that has been loaded in a RAM of the information processing terminal 200 by using a CPU. In addition, the terminal information memory unit 220 is configured by a memory device such as a ROM or a hard disk.

The management unit 210 manages the printer driver (including a printer driver unit 230 to be described later) of the information processing terminal 200. For example, the management unit 210 performs a process for installing the printer driver to the information processing terminal 200. When a printer driver is to be installed for the first time after the information processing terminal 200 is purchased, the management unit 210 acquires printer information on a printer 300 from the printer 300 associated with the printer driver and registers the terminal information on the information processing terminal 200 in the second server 100 together with the acquired printer information. In addition, the management unit 210 performs a process for updating (including updating and downdating) the printer driver.

The terminal information memory unit 220 records terminal information on the information processing terminal 200. For example, the terminal information includes information on the version of the installed printer driver, a terminal ID (MAC address), an assigned IP address, a terminal model name, a printer (serial number) that can be controlled by the information processing terminal 200, and the like.

The printer driver unit 230 serves as a printer driver that controls the printer 300 that is connected to the local network 50. Here, the printer driver unit 230 is a printer driver that has been installed to the information processing terminal 200 and does not include printer drivers (for installation) that have not been installed.

Next, the printer 300, as shown in the figure, includes a management unit 310, a printer information memory unit 320, and a firmware unit 330. The management unit 310 and the firmware unit 330 are configured by executing a computer program that has been loaded into a RAM of the printer 300 by using a CPU. Alternatively, the management unit 310 and the firmware unit 330 may be configured by operating ASICs (application specific integrated circuits) that are dedicated for implementing functions thereof. In addition, the printer information memory unit 320 is configured by a memory device such as a ROM.

The management unit 310 manages the firmware (including the firmware unit 330 to be described later) of the printer 300. For example, the management unit 310 performs a process for updating the firmware that has been installed to the printer 300. In addition, the management unit 310 transmits printer information to be described later to the information processing terminal 200 in response to a request from the information processing terminal 200.

The printer information memory unit 320 records printer information on the printer 300. For example, the printer information includes information on the version of the installed firmware, a printer ID (serial number), an assigned 12 address, a printer model name, and the like.

The firmware unit 330 serves as a firmware that controls the printer 300.

Next, a characteristic operation of the network system 10 having the above-described configuration will be described.

### Registration Process

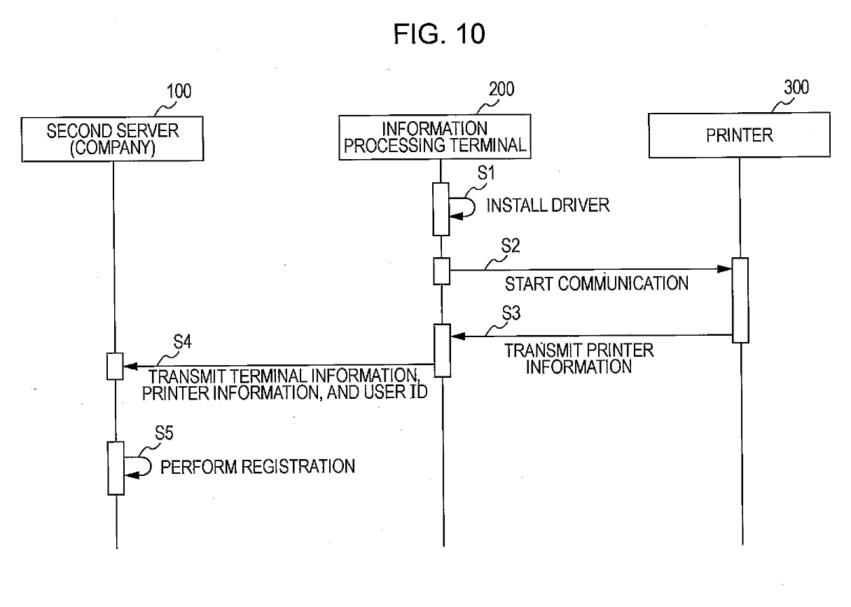

FIG. 10 is a timing chart showing the registration process in the network system 10.

First, the management unit 210 of the information processing terminal 200 performs a process for installing the printer driver, which has been compressed or the like for installation, to the information processing terminal 200 (Step S1). For example, the management unit 210 reads out a printer driver (a program for installation) that is stored in a portable memory medium (a CD-ROM, a USB memory, or the like) and installs the printer driver. Alternatively, the management unit 210 may be configured to acquire a printer driver (a program for installation), which is stored in the second server 100, through the local network 50 and install the printer driver.

After installing the printer driver, the management unit 210 starts communicating with the printer 300 that can be controlled by the installed printer driver (the printer driver unit 230) (Step S2). For example, the management unit 210 requests the printer 300 for the printer information through the local network 50.

When starting to communicate with the information processing terminal 200, the management unit 310 of the printer 300 transmits the printer information that is stored in the printer information memory unit 320 to the information processing terminal 200 (Step S3).

When receiving the printer information that has been transmitted from the printer 300, the management unit 210 of the information processing terminal 200 reads out the terminal information that is stored in the terminal information memory unit 220 and transmits the received printer information, the output terminal information, and the employee ID that is input from a keyboard or the like by the user to the second server 100 (Step S4).

Here, before transmitting the above-described information to the second server, the management unit 210 of the information processing terminal 200 must specify the second server 100 on the local network 50. A method of specifying the second server may be any arbitrary method. For example, one of the following three methods may be used as the method of specifying the second server.

### (1) First Specifying Method

In the portable memory medium that is distributed by a maker, specific information (for example, the URL information) of the second server 100 is stored in advance together with the printer driver (for installation), and the management unit 210 specifies the second server 100 by reading out the specific information.

### (2) Second Specifying Method

When the portable memory medium on which the printer driver (for installation) is stored is distributed by a maker, the second server 100 (management unit 110) stores the specific information (for example, URL information) on the second server 100 on the portable memory medium. Then, the portable memory medium is distributed to each employee, and the management unit 210 of the information processing terminal 200 reads out the specific information from the distributed portable memory medium so as to specify the second server 100.

### (3) Third Specifying Method

In an installer (program) for performing an installation operation in Step S1, a module is included for searching for the second server 100 on the local network 50. Thus, the management unit 210 of the information processing terminal 200 specifies the second server 100 in accordance with the module.

In addition, after specifying the second server 100 by using the above-described specifying method, the management unit 110 stores the specific information in the memory unit 130. When transmitting data to the second server 100 (communicating with the second server 100), the management unit 110 specifies the second server 100 in advance by using the specific information stored in the memory unit 130.

Next, when receiving the terminal information, the printer information, and the employee ID that are transmitted from the information processing terminal 200, the management unit 110 of the second server 100 registers the received information (Step S5).

For example, the management unit 110, first, searches for the received employee ID from the user management table 134. When the corresponding employ ID 1341 exists in the user management table 134, the management unit registers the terminal information and the printer information. In particular, the management unit 110 adds a record 1316, in which each piece of information (the terminal ID, the IP address, the terminal model name, the printer driver version, and the registered printer) that is included in the received terminal information is associated with one other, in the terminal information table 131. In addition, the management unit 110 adds a record 1325, in which each piece of information (the printer ID, the IP address, the printer model name, and the firmware version) included in the received printer information is associated with one another, in the printer information table 132.

On the other hand, when the received employee ID does not exist in the user management table 134, the management unit 110 notifies the information processing terminal 200 of an error.

In addition, even when the corresponding employee ID 1341 exists in the user management table 134, the management unit 110 may be configured not to perform the registration operation but to notify there has been an error for an employee (user) who is not permitted to use the information processing terminal 200. In particular, the management unit 110 reads out a use-permitted terminal 1343 associated with the found employee ID 1341 from the user management table 134 and compares the output use-permitted terminal 1343 with the terminal ID that is included in the received terminal information. Then, when the output use-permitted terminal does not coincide with the terminal ID included in the received terminal information, the management unit 110 notifies there has been an error.

By performing the above-described registration process, the network system 10 according to this embodiment can register information devices (the plurality of the information processing terminals 200 and the plurality of the printers 300) inside the company (local network 50) in the second server 100. In addition, accordingly, the second server 100 can manage versions of the printer drivers that are installed to the information processing terminals 200 and the firmware that are installed to the printers 300.

### Version Update Process

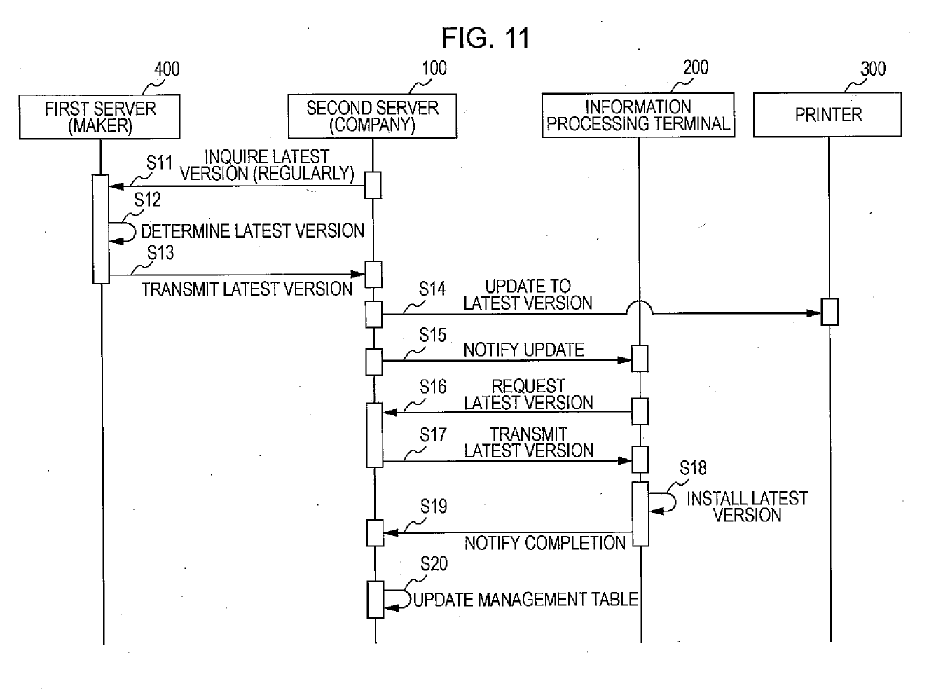

FIG. 11 is a timing chart showing the version update process in the network system 10.

First, the management unit 110 of the second server 100 makes inquiries to the first server 400 on a regular basis to determine whether there is the latest version of the printer driver or the latest version of the firmware (Step S11). In particular, the management unit 110 transmits all the terminal model names 1313 and the printer driver version information 1314 that are stored in the terminal information table 131 and all the printer model names 1323 and the firmware version information 1324 that are stored in the printer information table 132, the company ID for identifying the company that owns the second server 100, and a password input by a user together to the first server 100 (through the global network 60). In addition, as described above, the printer driver version information 1314 included in the terminal information table 131 represents the versions of the printer drivers that have been actually installed to the information processing terminals 200, and the firmware version information 1324 included in the printer information table 132 represents the versions of the printer drivers that have been actually installed to the printers 300.

Subsequently, the service providing unit 410 of the first server 400 receives the inquiry from the second server 100 and determines whether there are the latest version of the printer driver (a version newer than the actually installed version) and the latest version of the firmware. When there are the latest version of the printer driver and the latest version of the firmware, the service providing unit 410 determines the latest version of the printer driver and the latest version of the firmware (Step S12).

In particular, the service providing unit 410, first, searches for the company ID that has been transmitted from the second server from the company management table 421 in which company IDs are registered in advance. When there is the corresponding company ID 4211 in the company management table 421, the service providing unit 410 determines whether the password that has been transmitted from the second server coincides with the password 4214 that is associated with the company ID 4211. On the other hand, when the corresponding company ID is not included in the company management table 421 or when the passwords do not coincide with each other, the service providing unit 410 notifies the second server 100 that there has been an error without performing the process for determining whether there are the latest version of the printer driver and the latest version of the firmware.

On the other hand, when the passwords coincide with each other, the service providing unit 410 reads out the program management table 422 and searches for a record that has the printer model name 1323 and the terminal model name 1313 that have been transmitted from the second server 100. Then, the service providing unit 410 extracts version information of the latest firmware 4222 and the latest printer driver 4224 that are associated with the found record.

Here, the service providing unit 410 compares the extracted latest firmware 4222 with the firmware version information 1324 that has been transmitted from the second server 100. As the result of the comparison, when the latest firmware that is stored in the program management table 422 is a new version, the service providing unit 410 determines the latest firmware 4222 to be the latest version of the firmware.

Likewise for the printer driver, the service providing unit 410 compares the extracted latest printer driver 4224 with the printer driver version information 1314 that has been transmitted from the second server 100. As the result of the comparison, when the latest printer driver 4224 stored in the program management table 422 is a version newer than the printer driver version information, the service providing unit 410 determines the latest printer driver 4224 to be the latest version of the printer driver.

Then, the service providing unit 410 transmits the determined latest firmware 4222 or the latest printer driver 4224 together with the printer model name 4221 associated with the latest firmware 4222 and the terminal model name 4223 associated with the latest printer driver 4224 to the second server 100 (Step S13). On the other hand, when there is no version (the latest version) that is newer than the printer driver or the firmware that has been installed to the information devices (the information processing terminal 200 and the printer 300) in the program management table 422, the service providing unit 410 notifies the second server 100 that there is no latest version of the printer driver or latest version of the firmware.

When receiving the latest firmware 4222 in Step S13, the management unit 110 of the second server 100 installs (updates) the received latest firmware 4222 to the printer 300 (Step S14). In particular, first, the management unit 110 searches for the printer model name 4221 that has been received together with the latest firmware 4222 from the printer information table 132. Then, the management unit 110 transmits the received latest firmware 4222 to the printer 300 that is specified in accordance with the printer ID 1321 (the IP address 1322) associated with the found printer model name 1323. At this moment, the management unit 310 of the printer 300 receives the latest firmware 4222 and updates the firmware that has been installed.

In addition, when receiving the latest printer driver 4224 in Step S13, the management unit 110 of the second server 100 notifies the information processing terminal 200 that there is an update (Step S15). In particular, first, the management unit 110 searches for the terminal model name 4223 that has been received together with the latest printer driver 4224 from the terminal information table 131. Then, the management unit 110 notifies the information processing terminal 200 that is specified in accordance with the terminal ID 1311 (the IP address 1312) associated with the found terminal model name 1313 of the update.

When receiving the notification of the update, the management unit 210 of the information processing terminal 200 makes a request to the second server 100 for the printer driver (the latest printer driver 4224) of the latest version based on an instruction from a user (Step S16).

The management unit 110 of the second server 100 that has received this request transmits the latest printer driver 4224 received in Step S13 to the information processing terminal 200 that has transmitted the request in Step S16 (Step S17).

The management unit 210 of the information processing terminal 200 that has received the latest printer driver 4224 installs (updates) the received latest printer driver 4224 to the information processing terminal 200 (Step S18).

When the installation (update) is completed, the management unit 210 notifies the second server 100 of the completion of the installation (update) (Step S19).

Subsequently, the management unit 110 of the second server 100 updates data in the program management table 133 (Step S20).

In particular, when receiving the latest firmware 4222 in Step S13, the management unit 110 reads out the program management table 133 and searches for the printer model name 4221 that has been received together with the latest firmware 4222 from the program management table 133. Then, the management unit 110 updates (overwrites) the firmware 1332 associated with the found printer model name 1331 with the latest firmware 4222 of the correct version that has been received in Step S13. In addition, even when having not received a notification in Step S19, the management unit 110 updates the latest firmware 4222.

In addition, when having received the latest printer driver 4224 in Step S13 and received the notification in Step S19, the management unit 110 reads out the program management table 133 and searches for the terminal model name 4223 received together with the latest printer driver 4224 in Step S13 from the program management table 133. Then, the management unit 110 updates (overwrites) the printer driver 1334 associated with the found terminal model name 1333 with the latest printer driver 4224 of the correct version received in Step S13.

Then, the management unit 110 also updates the printer information table 132 and the terminal information table 131. For example, the management unit 110 updates (overwrites) the firmware version information 1324 associated with the printer ID 1321 of the printer 300 that has been updated in Step S14 with the version information of the latest firmware 4222 that has been updated in Step S14. In addition, the management unit 110 updates (overwrites) the printer driver version information 1334 associated with the terminal ID 1331 of the information processing terminal 200 that has been installed (updated) in Step S18 with the version information of the latest printer driver 4224 that has been installed (updated) in Step S18.

In the network system 10 that performs the above-described version update process, a process for communicating with the first server 100 is performed not with the information devices (the information processing terminal 200 and the printer 300) as individual units but with the companies (the second server 100) as individual units. Accordingly, the volume of the global network 60 can be reduced. In addition, various types of information need not to be transmitted to the first server 100 from each information device. Accordingly, leakage of personal information and the like can be prevented, and a security problem does not easily occur.

### Fault Detecting Process

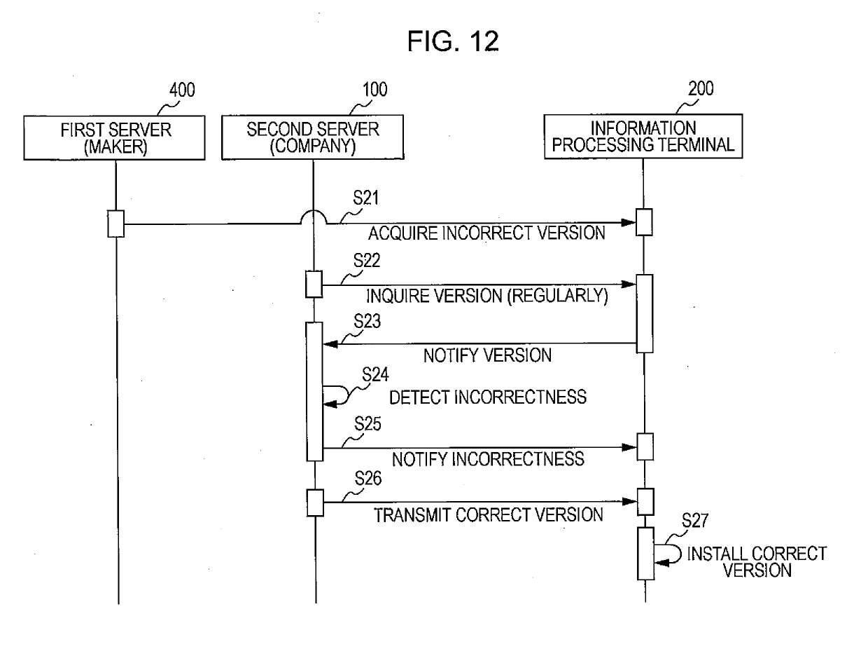

FIG. 12 is a timing chart showing the fault detecting process in the network system 10.

It is assumed that the management unit 210 of the information processing terminal 200 has acquired (installed) a printer driver of an incorrect version from the first server 400 or the like by using any arbitrary method (Step S21). Here, the incorrect version indicates a version that is different from the version (correct version) of the printer driver 1334 stored in the program management table 133.

The fault detecting unit 120 of the second server 100 makes inquires to the information processing terminal 200 on a regular basis to determine the version information of the installed printer driver regardless of whether a printer driver of an incorrect version is installed to the information processing terminal 200 (Step S22). In particular, the fault detecting unit 120 makes requests on a regular basis to the information processing terminal 200, which is connected to the local network 50, for the version information of the installed printer driver.

The management unit 210 of the information processing terminal 200 notifies the second server 100 of the version information of the installed printer driver and the terminal ID (Step S23). In particular, the management unit 210 reads out the version information and the terminal ID that are stored in the terminal information memory unit 220 and transmits the output version information to the second server 100.

Here, the fault detecting unit 120 of the second server 100 that has received the version information and the terminal ID reads out the terminal information table 131 and searches for the terminal ID that has been received from the information processing terminal 200. Then, the fault detecting unit 120 updates the printer driver version information 1314 associated with the found terminal ID 1311 with the version information that has been received from the information processing terminal 200.

Subsequently, the fault detecting unit 120 detects the printer drivers that have been incorrectly installed to the information processing terminal 200 (Step S24). In particular, first, the fault detecting unit 120 specifies the terminal model name 1313 associated with the terminal ID 1311 that has been received in Step S23 from the terminal information table 131. Then, the fault detecting unit 120 extracts the version information (correct version) of the printer driver 1334 associated with the specified terminal model name 1313 (the terminal model name 1333) from the program management table 133. Then, the fault detecting unit 120 compares the version information received in Step S23 with the version information (correct version) extracted from the program management table 133. Here, when the version information received in Step S23 and the version information extracted from the program management table 133 coincide with each other, the fault detecting unit 120 determines that the printer driver installed to the information processing terminal 200 is the correct version. On the other hand, when the version information received in Step S23 and the version information extracted from the program management table 133 do not coincide with each other, the fault detecting unit 120 determines that the printer driver installed in the information processing terminal 200 is an incorrect version.

The fault detecting unit 120 notifies the information processing terminal 200, to which the printer driver determined to be an incorrect version in Step S24 has been installed, of the fault (Step S25). In particular, first, the fault detecting unit 120 reads out the terminal information table 131 and specifies the terminal ID 1311 (IP address 1312) associated with the printer driver version 1314 of the printer driver that has been determined to be an incorrect version. Then, the fault detecting unit 120 notifies the information processing terminal 200 specified by the specified terminal ID 1311 (IP address 1312) of the fault.

Then, the fault detecting unit 120 transmits the printer driver of the correct version to the information processing terminal 200 (Step S26). In particular, the fault detecting unit 120 transmits the printer driver 1334 of the correct version extracted from the program management table 133 in Step S24 to the information processing terminal 200 that has been notified of the fault in Step S25.

When receiving the printer driver 1334 of the correct version, the management unit 210 of the information processing terminal 200 installs (updates or downdates) the printer driver 1334 to the information processing terminal 200 (Step S27).

When installation (update or downdate) is completed, the management unit 210 notifies the second server 100 of the completion of the installation (update or downdate) (Step S28).

Subsequently, the management unit 110 of the second server 100 updates data in the program management table 133 (Step S29).

In particular, the management unit 110 specifies the terminal ID 1311 of the information processing terminal 200 that has transmitted the printer driver 1334 in Step S26 from the terminal information table 131. In addition, the management unit 110 updates (overwrites) the printer driver version information 1314 associated with the specified terminal ID 1311 with the version information (correct version) of the printer driver that has been transmitted to the information processing terminal 200.

By performing the above-described fault detecting process, in the network system 10 according to this embodiment, there can be prevention of printer drivers of an incorrect version, that is, a version that is not the latest version or a version that is not designated (recommended) by the company, being installed to the information processing terminal 200.

The invention is not limited to the above-described embodiment and may be changed or applied in various forms.

For example, the registration information (the printer information table 132) of the printer 300 in the second server 100 may be configured to be updated as needed when the IP address assigned to the printer 300 is changed.

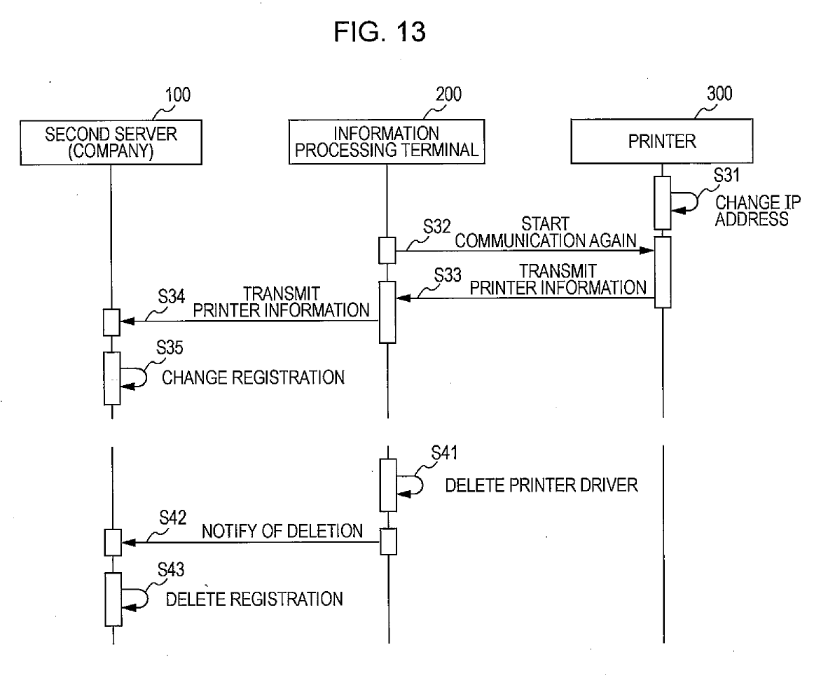

FIG. 13 (upper stage) is a flowchart showing a process for cases where the IP address of the printer 300 is changed.

As show in the figure, when the IP address assigned to the printer 300 is changed (Step S31), the management unit 310 of the printer 300 changes the IP address that is stored in the printer information memory unit 320.

The management unit 210 of the information processing terminal 200 starts re-communicating with the printer 300 which is unable to communicate (Step S32). In particular, the management unit 210 searches for a printer 300 that has the printer ID of the printer 300 which is unable to communicate from the local network 50 and restarts communicating with the found printer 300.

Then, the management unit 310 of the printer 300 transmits the printer information stored in the printer information memory unit 320 to the information processing terminal 200 that has restarted communication (Step S33).

The management unit 210 of the information processing apparatus 200 transmits the received printer information to the second server 100 (Step S34).

When the printer information is received, the management unit 110 of the second server 100 changes the registration information (the printer information table 132) of the printer 300 (Step S35). In particular, the management unit 110 searches for a printer ID included in the printer information, which has been received from the information processing terminal 200, from the printer information table 132. Then, the management unit 110 updates (overwrites) the IP address 1322 associated with the found printer ID 1321 with the IP address included in the received printer information.

By performing the above-described process, the printer information table 132 managed by the second server 100 can be appropriately updated even when the IP address assigned to the printer 300 is changed.

In addition, for example, the registration information (the terminal information table 131) of the information processing terminal 200 in the second server 100 may be configured to be updated when the printer driver installed to the information processing terminal 200 is deleted.

FIG. 13 (lower section) is a flowchart showing a process for the case where the printer driver installed to the information processing terminal 200 is deleted.

As shown in the figure, when the printer driver installed to the information processing terminal 200 is deleted (Step S41), the management unit 210 of the information processing terminal 200 deletes the version information that is stored in the terminal information memory unit 220.

Subsequently, the management unit 210 notifies the second server 100 of deletion of the printer driver together with the terminal ID (Step S42).

Then, when the notification is received from the information processing terminal 200, the management unit 110 of the second server 100 changes the registration information (the terminal information table 131) of the information processing terminal 200 (Step S43). In particular, the management unit 110 searches for the terminal ID, which has been received from the information processing terminal 200, from the terminal information table 131. Then, the management unit 110 changes the printer driver version information 1314 associated with the found terminal ID 1311 to invalid data (for example, “none”).

By performing the above-described process, even when the printer driver installed to the information processing terminal 200 is deleted, the terminal information table 131 that is managed by the second server 100 can be appropriately changed.

The entire disclosure of Japanese Patent Application No. 2008-266032, filed Oct. 15, 2008 is expressly incorporated by reference herein.

What is claimed is:

1. A network system comprising:
a first server that is located on a service providing side;
a second server that is located on a service receiving side;
a plurality of printer hosts that is connected to a local network on the second server side; and
a plurality of printers that is connected to the local network,
wherein the second server includes:
a memory unit that stores information on the versions of printer drivers installed to the plurality of printer hosts and firmware installed to the plurality of printers; and
a version management unit that makes inquires on a regular basis to determine whether there is the latest version of a printer driver or the latest version of a firmware by transmitting company information, which specifies a company that owns the second server, to the first server together with the version information,
wherein the first server includes:
a first memory unit that stores the latest version of the printer driver and the latest version of the firmware;
a second memory unit that stores permission information that is used for determining a company to which the latest version of the printer driver and the latest version of the firmware are permitted to be provided; and
a providing unit that provides the second server with the latest version of the printer driver or the latest version of the firmware stored in the memory unit for cases where the latest version stored in the memory unit is newer than the version represented by the version information that has been transmitted from the second server only when the company information transmitted from the second server is included in the permission information,
wherein the version management unit of the second server notifies the printer host of the provision of the latest version of the printer driver for cases where the latest version of the printer driver is provided, and transmits the latest version of the firmware to the printer for cases where the latest version of the firmware is provided,
wherein the printer host includes:
an acceptance unit that accepts a user's instruction indicating whether to download the latest version of the printer driver for cases where the notice is accepted; and
a request unit that requests the second server for the latest version of the printer driver for cases where the instruction for downloading is accepted by the acceptance unit, and
wherein the printer includes a firmware management unit that installs the latest version of the firmware transmitted from the second server.

2. The network system according to claim 1,
wherein the memory unit of the second server stores the IP addresses of the plurality of printers on the local network in association with the information on the versions of the firmware that are installed to the plurality of printers,
wherein the firmware management unit of the printer transmits the IP address of the printer after it has been changed to the second server through the printer host for cases where the IP address of the printer on the local network has been changed,
wherein the version management unit of the second server changes the IP address of the printer that is stored in the memory unit to the IP address of the printer after it has been changed that has been transmitted from the printer.

3. The network system according to claim 1,
wherein a printer driver management unit of the printer host notifies the second server of deletion of the installed printer driver for cases where the installed printer driver is deleted, and
wherein the version management unit of the second server updates the version information of the printer driver that has been installed to the printer host.

4. A server apparatus that receives a service from a predetermined server apparatus that provides the service,
wherein a plurality of printer hosts and a plurality of printers are connected to a local network on the server apparatus side,
the server apparatus comprising:
a memory unit that stores information on the versions of printer drivers installed to the plurality of printer hosts and firmware installed to the plurality of printers; and
a version management unit that makes inquiries on a regular basis to determine whether there is the latest version of a printer driver or the latest version of a firmware by transmitting company information, which specifies a company that owns the server apparatus, to the predetermined server apparatus that provides the service together with the version information,
wherein the version management unit notifies the printer host of the provision of the latest version of the printer driver for cases where the latest version of the printer driver is provided from the predetermined server apparatus, and transmits the latest version of the firmware to the printer so as to be installed for cases where the latest version of the firmware is provided.

5. A printer host that is connected from a first server providing a service to a second server receiving the service and a plurality of printers through a local network and can control the plurality of printers, the printer host comprising:
an acceptance unit that accepts a user's instruction indicating whether to acquire the latest version of the printer driver when there is notification from the second server that the latest version of the printer driver has been provided from the first server to the second server;
a printer driver management unit that acquires and installs the latest version of the printer driver from the second server for cases where the instruction for acquiring the latest version of the printer driver is accepted by the acceptance unit; and
a notification unit that notifies the second server of the completion of the installation for cases where the installation of the printer driver is completed.
